(19) United States
(12) Patent Application Publication
(10) Pub. No.: US 2019/0354962 A1
(43) Pub. Date: Nov. 21, 2019

(54) Distributed Ledger Payments Platform for Telecoms

(71) Applicant: Qredo Ltd., London (GB)

(72) Inventor: Brian Spector, London (GB)

(73) Assignee: Qredo Ltd., London (GB)

(21) Appl. No.: 16/415,113

(22) Filed: May 17, 2019

Related U.S. Application Data
(63) Continuation of application No. 62/673,706, filed on May 18, 2018.

(51) Int. Cl. G06Q 20/36; G06Q 20/38; G06F 16/901

(52) U.S. Cl. CPC G06Q 20/3674; G06Q 20/38215; G06F 16/9024; G06Q 20/3827; G06Q 20/3678

(57) ABSTRACT

A distributed ledger system for cryptocurrency transactions uses two types of Directed Acyclic Graph (DAG) technologies into a dual chain architecture. Every transaction creates a unique identifier in the first graph is utilized to refer to a more expansive set of data housed within the second graph.

### PRIORITY CLAIM

This is a utility patent application that claims priority as a continuation of U.S. Provisional Pat. App. No. 62/673,706, filed on May 18, 2018 which is hereby incorporated by reference in its entirety for all that it teaches.

### FIELD OF INVENTION

The present invention generally relates to the field of data encryption processes for crypto-currency or other digital asset transactions.

### BACKGROUND

The design of the Qredo distributed ledger cryptocurrency and payment protocols reflect the known requirements of mobile operators, consumers, merchants and governments for a safe, secure, interoperable mobile payments network that works across borders and carriers.

Design choices encompass many elements as further set forth below, from the selection of the quantum-resistant cryptographic protocols to the modular design of Qredo's software stack to the economic models used to drive incentives on the Qredo network.

Many of the design choices are intended to deal with the realities of moving money internationally, of complying with the multitude of financial services regulations that are specific to various domiciles and governments. Compliance with privacy legislation such as GDPR and a forward look to guaranteeing consumer privacy and security, along with the need for telecoms to interact with governments and comply with investigatory or legal intercept mandates are critical requirements. Reducing fraud while increasing consumer protection in itself is a significant design factor.

The resulting work created a cryptocurrency architecture wholly unique among others in the field, as evidenced by Qredo's Proof of Speed transaction validation protocol and incentive paradigm, its use of modular components addressing cloud and mobile deployment realities, and an API first design that envisions an ecosystem of participants that can create real value around extending core services.

Qredo can be used as a secure, completely anonymous cryptocurrency and is by no means limited to use among mobile operators and network service providers. The full Qredo client is capable of running in the cloud, on the desktop or smartphone. However, Qredo differentiates itself through a modular design that recognizes the fact that most consumers in the world want to transact as directly and conveniently as possible, without the need to procure cryptocurrency online through an exchange, just to buy a coffee at Starbucks.

The needs of the telecoms industry dictate Qredo's development direction. Our emphasis now is to facilitate cross-border, cross telecom payments, but as the protocol matures, ample room remains to extend Qredo to solve industry challenges such as fraud prevention and IoT device and data security and IOT initiated payments.

### SUMMARY

Qredo is building a distributed ledger system harnessing two types of Directed Acyclic Graph (DAG) technologies into a dual chain architecture. The rationale behind having two graphs, or chains, addresses critical commercial realities. First, the current performance issue that plagues current cryptocurrency 1.0 solutions like Bitcoin and Ethereum regarding transaction velocity. The second is a recognition that telecoms entering financial services must adhere to a broad set of regulatory regimes that include legal intercept to GDPR, and all other domicile specific regimes regulating financial services, KYC, and AML.

### DESCRIPTION OF THE FIGURES

The headings provided herein are for convenience only and do not necessarily affect the scope or meaning of the claimed invention. In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 204 is first introduced and discussed with respect to FIG. 2).

FIG. 1. Direct acyclic graph

FIG. 2. Direct acyclic graph with checkpoint

FIG. 3. Coopetition among Minters

FIG. 4 Successful Minters are compensated when a checkpoint becomes permanent

FIG. 5 Threshold Ring Private Key Distribution.

FIG. 6 Key Distribution, Checkpoint Message Signature and Distribution

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other features not described in detail herein. Additionally, some well-known structures or functions may not be shown or described in detail below, so as to avoid unnecessarily obscuring the relevant description. The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section. References to Qredo are the name of a service that has implemented the invention. The Qredo Server executes the server processes in accordance with the invention and the Qredo App can execute either the principal, beneficiary or fiduciary processes.

The graph, or chain, that is utilized by all Qredo clients is called Graph A. Graph B is a semi-permission chain operated and maintained by telecoms or other entities also operating a Qredo transaction validation node, called a Qredo Minter.

Graph A utilizes a code-based post-quantum secure ring signature algorithm as described in S. Chen, K. Chao, X. Doug, and P. Zeng. Efficient Ring Signature and Group Signature Schemes Based on q-ary Identification Protocols. The British Computer Society, 2017, incorporated by reference herein, to achieve extremely high levels of anonymity about the transaction participants, and a non-interactive zero-knowledge proof protocol, as described in B. Bu\ddot{ }nz, B. Bootle, D. Boneh, A. Poelstra, P. Wuille, and G. Maxwell. Bulletproofs: Short Proofs for Confidential Transactions and More. Cryptology ePrint Archive, Report 2017/1066, 2017 incorporated by reference herein, for transaction confidentiality as described by J. Bootle and J. Groth. Efficient batch zero-knowledge arguments for low degree polynomials. Cryptology ePrint Archive, Report 2018/045, 2018. incorporated by reference herein, so the details are secured. Transactions in graph A are formalized by Qredo Minters using a coopetition model called Proof of Speed.

Proof of Speed is an incentive paradigm with foundations derived from the conditions of pre-selection of public parameters using a post-quantum secure threshold ring signature scheme described by S. Chen, K. K. R. Choo, P. Zeng, G. Zhou, and X. Yuan. An Efficient Code-Based Threshold Ring Signature Scheme with a Leader-Participant Model. In Security and Communication Networks. Hindawi, 2017 incorporated by reference herein, together with a distributed public randomness beacon as described by E. Syta, P. Jovanovic, E. K. Kogias, N. Gailly, L. Gasser, I. Khoffi, M. J. Fischer, and B. Ford. Scalable bias-resistant distributed randomness. Cryptology ePrint Archive, Report 2016/1067, incorporated by reference herein. A threshold ring signature scheme effectively proves that a minimum number of users of a certain group must have actually collaborated to produce a signature on a message, while hiding the precise membership of the subgroup described by C. Aguilar, P.-L. Cayrel, P. Gaborit, and F. Laguillaumie. A new efficient threshold ring signature scheme based on coding theory and incorporated by reference herein. Stated another way, a (t, N) threshold ring signature scheme allows at least t signers in the ring of N signers to cooperate with each other to sign a message without leaking any identity information of the t signers.

Every transaction creates a unique identifier in Graph A, which can be utilized as a pointer back to a more expansive set of data housed within Graph B. A Qredo management service operated by telecoms or other entities is used to create this link. An unmanaged Qredo client produces an orphan identifier in Graph A, i.e., no resulting link to Graph B. These transactions remain entirely anonymous and opaque outside of the transaction participants. Materially, these are the only transactions that will require a transaction fee to be paid to a Minter, explained in the following section detailing the Proof of Speed paradigm.

Graph B runs a permission-less tamper-proof graph structure described by P. Otte, M. D. Vos, and J. Pouwelse. TrustChain: A Sybil-resistant scalable blockchain. Future Generation Computer Systems, 2017 and incorporated by reference herein, for storing transaction records of subscribers between telecoms, creating an immutable chain of temporally ordered interactions that happen between each subscriber in each telecom. These records in Graph B use the unique transaction record established in Graph A.

Graph B stores an order of magnitude more data than Graph A. Graph B includes all the transaction information necessary to be compliant in a regulated financial services environment and adhere to strict AML and KYC safeguards. Think of Graph B as a shared compliance database spanning a consortium of telecoms and network service providers running on top of a completely anonymous cryptocurrency (Graph A).

The information stored in Graph B becomes secured, and non-repudiated, by encrypting the uniformly written data written using a shared key described by C. Costello, L. D. Feo, D. Jao, P. Longa, M. Naehrig, and J. Renes. Supersingular isogeny key encapsulation.

Internet, 2017 and incorporated by reference herein between the two transacting telecoms with AES-256 symmetric encryption, itself believed to be quantum-resistant at this time. Encrypted information in Graph B is only accessible by each telecom or service provider involved in the transaction, but not to other Graph B operators/telecoms who receive updates to the entire Graph B chain; they do not have access to the agreed symmetric key.

Graph B encrypted transactions are replicated widely across all operators. This replication makes the system resilient but also enables non-repudiation of transactions between telecoms themselves, i.e., a hash of the encrypted data structure comprising the transaction issued by Telecom A should be the same as the corresponding one published by Telecom B.

A transaction needs two signatures on Graph B, one from each issuing telecom, to have the final signature process completed by other telecoms selected to validate that particular transaction, a design called ‘stacked signatures’. The entries in Graph B are signed by Qredo Minters once each telecom mutually signs the other's Graph B entry of the same transaction. If transactions happen between subscribers of the same telecom, the transaction will be issued and signed twice by the same telecom.

Each Graph B operator decides on their bulk storage of transactions, resulting in partial storage of the global directed graph, as other transactions on the chain are encrypted, irrelevant to their operations and inaccessible in any case.

As each telecom creates their unique copy of their chain, so it becomes an accurate historical transaction record of activity between its mobile subscribers (whether they be consumers, merchants or enterprises) and the mobile subscribers on other telecoms.

Graph B's key agreement algorithm can be invoked at any time to generate the AES key to decrypt information as required in legal intercept or dispute resolution scenarios. An advantage of Qredo's quantum resistant key agreement implementation is that long-term storage of symmetric keys used to decrypt Graph B transactions is not necessary. Only the parameters and secrets generated by the telecom before the key agreement protocol are required.

Qredo Minter's receive Qredo by validating both sets of transaction data in Graph A and Graph B. First in Graph A, which then creates the responsibility for the Minter to confirm the signatures behind the encrypted entries in Graph B. These responsibilities form one of the underlying basis of the Qredo protocol itself. That is, the advantages that come with a consortium network of permissioned transaction validators running on top of a permission-less chain.

Qredo Minters secure their license to operate a Minter Server, called a Minter Medallion, by buying into the network in one of two ways. First, either initially through Qredo's auction of Minter Medallions, or, after the establishment of the Qredo network is operational, buy buying into the Qredo network as a new Minter Medallion owner.

Establishing this consortium model up front, before the establishment of the network, removes the centralization risks that hamper other implementors of Directed Acyclic Graphs, such as IOTA. IOTA has a central point of failure. Analysis of its current design revealed a 34% attack by dishonest participants on IOTA is equivalent to a 51% attack of dishonest miners on Bitcoin. The IOTA network created a temporary centralised element—the Coordinator node (“Coo”)—to prevent malicious activity in awareness of this issue. For now, every transaction goes through Coo to be validated and, therefore, at this point, a centralised entity is directing the path of the IOTA's DAG tree.

This arrangement also results in the network's poor performance. According to the founders, COO is obsolete once the IOTA generates enough organic activity to be able to evolve unassisted. However, until the platform (without Coo) undergoes a maturation process in production, it is unknown if this scenario will result in success.

Qredo, by design, skips this weakness in DAG implementations with a pre-established consortium before its launch. Qredo rewards Minters for validating transactions with Qredo, inflating the supply of the cryptocurrency. A predetermined inflation rate is set before launching in a range of 2% per annum. The Qredo produced from inflation is the reward distributed to Qredo Minters.

These design choices reflect a belief that Qredo should be an actual currency or means of transacting value and not a digital store of value. Bitcoin, by any analysts' account, has failed as a currency because of the distortions created by its inbuilt scarcity of supply.

A natural question to be asked: What are the incentives for Minters for honest behavior? Qredo takes the approach that a Minter Medallion is an optionally renewed token to create a mechanism of enforcement on Minters for ethical conduct in addition to meeting commitments to uptime and availability.

Qredo's design seeks to enforce standards on Minters through the use of a time-bound Minter Medallion Token. As an example, a Minter's Medallion Token usage term is for six months, after which the Minter must exchange it's expiring Medallion Token for another ‘fresh’ medallion to keep running it's Minter service.

Qredo uses pairing-cryptography as described by M. Scott and A. Guillevic. A new family of pairing-friendly elliptic curves. Cryptology ePrint Archive, Report 2018/193, 2018. and incorporated by reference herein, to create a time-bound mechanism described by M. Scott and B. Spector. The carnac protocol—or how to read the contents of a sealed envelope. Cryptology ePrint Archive, Report 2015/576, 2015. and incorporated by reference herein that burns up a Minter Medallion if standards of performance and ethics are violated. The selection of these protocols and workflows are described in the following sections devoted to this mechanism. Qredo is actively researching alternative protocols that are quantum-resistant to achieve the same ends, and we expect further iterations to happen shortly.

One aspect that will remain is the intent that new Medallions are acquirable at any time after the Qredo network is established and operational for an, as of yet undetermined term. It is during this term that a ‘buy-in’ algorithm will determine the price of a Medallion Fee by taking as input several factors.

One such element may be what the potential revenue is for a new Medallion holder based on the growth rate and transaction velocity over the current term. Another may be what the potential costs are to existing Medallion holders currently on the network are for the release of an additional Medallion, hence reducing the potential revenue to existing holders. New York City, then this cost basis for Medallions should be familiar to you. It's how New York City taxicab medallions used to be bought and sold.

As the platform matures, it may be possible for a Minter to sell their Minter Medallion on an open market. Medallion Tokens can be bought/sold in secondary markets if the ‘Medallion Fee’ as set by the automated 1 IOTA has a central point of failure. Analysis of its current design revealed a 34% attack by dishonest participants on IOTA is equivalent to a 51% attack of dishonest miners on Bitcoin. The IOTA network created a temporary centralized element—the Coordinator node (“Coo”)—to prevent malicious activity in awareness of this issue. For now, every transaction goes through Coo to be validated and, therefore, at this point, a centralized entity is directing the path of the IOTA's DAG tree.

This arrangement also results in the network's poor performance. According to the founders, COO is obsolete once the IOTA generates enough organic activity to be able to evolve unassisted. However, until the platform (without Coo) undergoes a maturation process in production, it is unknown if this scenario will result in success For example, for residents of New York City, then this cost basis for Medallions should be familiar.

Qredo takes a component approach to separating the full Qredo client from a tethered Mobile Client/SDK. This decision stems from a desire to create payment token flows that can work with existing NFC technologies and yet are more secure and leaner than current payment mechanisms which utilize NFC channels.

A Qredo mobile payment token is secured using a quantum-resistant undeniable blind signature scheme as described by S. M. S. and V. Chandrasekaran. Isogeny-based quantum-resistant undeniable blind signature scheme. Cryptology ePrint Archive, Report 2016/148, 2016. and incorporated by reference herein that enable the extension of a managed full Qredo client onto a smartphone. We recognize the deployment characteristics of smartphones and IoT devices need to be handled differently than a desktop running a full Qredo client.

To this end a Qredo mobile client is cryptographically as described by] T. Gu\ddot{ }neysu and T. Oder. Towards lightweight Identity-Based Encryption for the post-quantum-secure Internet of Things. IEEE, 2017 and incorporated by reference herein, tethered to the full Qredo client so that the full Qredo client and tethered devices can be managed by a Management Service running in the cloud, as an example. The Mobile Token Flow and Mobile Client are designed to use the advancements and availability in the GSMA's RCS protocol in addition to NFC availability.

This extension model enables rapid deployment at telecom scale and addresses a multitude of payment scenarios including online, in-store and peer to peer, and eliminates the need for specialized payment terminals (i.e. card readers), a legacy tax on merchants worldwide. This architecture also makes possible open the embedding of Qredo Mobile Code code into multitudes of different applications running on smartphones and IoT devices via an SDK, so that payment between apps on a device, or between distinct IoT devices becomes a reality.

### 2. Proof of Speed

### 2.1. Introduction

Qredo is designed to be a two-tier system of users and validators (Qredo Minters), a permission-less chain with transactions validated by permissioned Qredo Minters, who may or may not be managing the Qredo full client that is creating the transaction, itself being directed by a tethered Mobile Client. How Minters are relegated to their roles will be covered further in a following section.

At its core, Proof of Speed is a consensus protocol that relies on a coopetition model, which became possible to implement because of advances in blockchain technology as described by X. Boyen, C. Carr, and T. Haines. Blockchain-free cryptocurrencies: A framework for truly decentralised fast transactions. Cryptology ePrint Archive, Report 2016/871, and incorporated by reference herein. Specifically, the maturing view that Direct Acyclic Graph (DAG) technologies can fix the performance issues that stymie the adoption of cryptocurrency 1.0 solutions like Ethereum and Bitcoin. However, these schemes have not yet proved to be the panacea that was originally promised.

In DAG based schemes such as Tangle, S. Popov. The tangle. Online, 2016. incorporated by reference herein and Byteball A. Churyumov. Byteball. Online, incorporated by reference herein, every node has their own hash chain. Transactions between nodes are recorded on their respective chains, avoiding global consensus to achieve robust scalability properties.

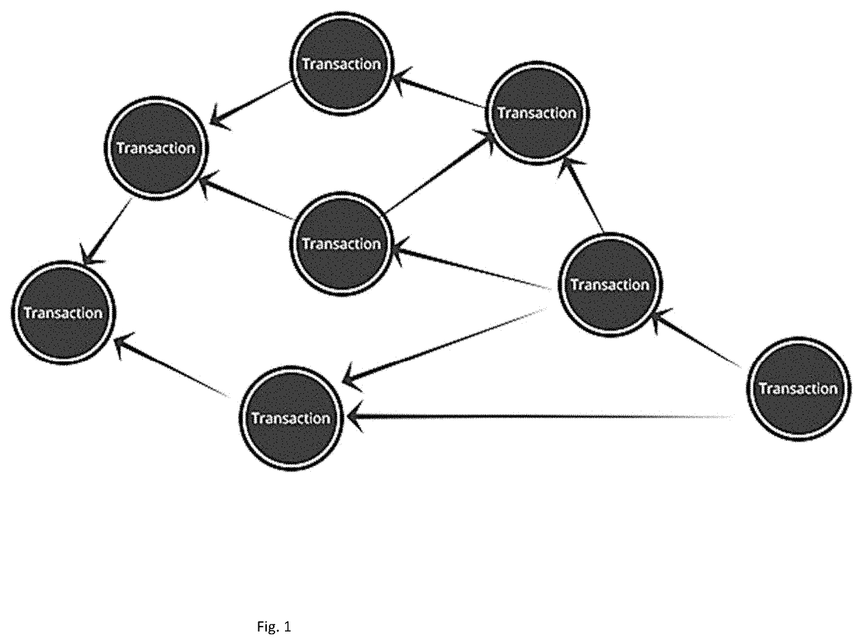

### See FIG. 1 Direct Acyclic Graph.

On the other hand, the application and security properties are limited. Nodes can lie to other nodes regarding its own chain by simply presenting one version of reality to a set of nodes and another version to a different set. Thus the network will have a conflicting view on the state of the malicious node.

Synchronization of a DAG has proved to be more difficult than the synchronization of a blockchain since the blockchain state is modified by every block while the DAG state is modified by every transaction.

Thus, what is required is a protocol which enables the Qredo's transaction validators, called Minters, to reach consensus on the transaction or state changes in a highly scalable and efficient way prohibiting double spending, and reducing the risk of centralization and/or sybil attacks among the group of Minters.

### 2.2. Coopetition Model

Qredo's coopetition model is built to reward Minters for the fastest transaction confirmations possible, and that happens by creating ‘checkpoints’ within the graph. Each created checkpoint solidifies the state of the chain and creates an unambiguous marker to protect against hidden branches, double spends, etc.

The checkpoint functions similarly to a block in a blockchain, but there are key differences. A checkpoint has no fixed size, isn't produced on any fixed schedule, and in Qredo's case, does not require the Minter to be aware of any items other than those transactions that link back to the last known checkpoint, via a hash of the last checkpoint inside the transaction message.

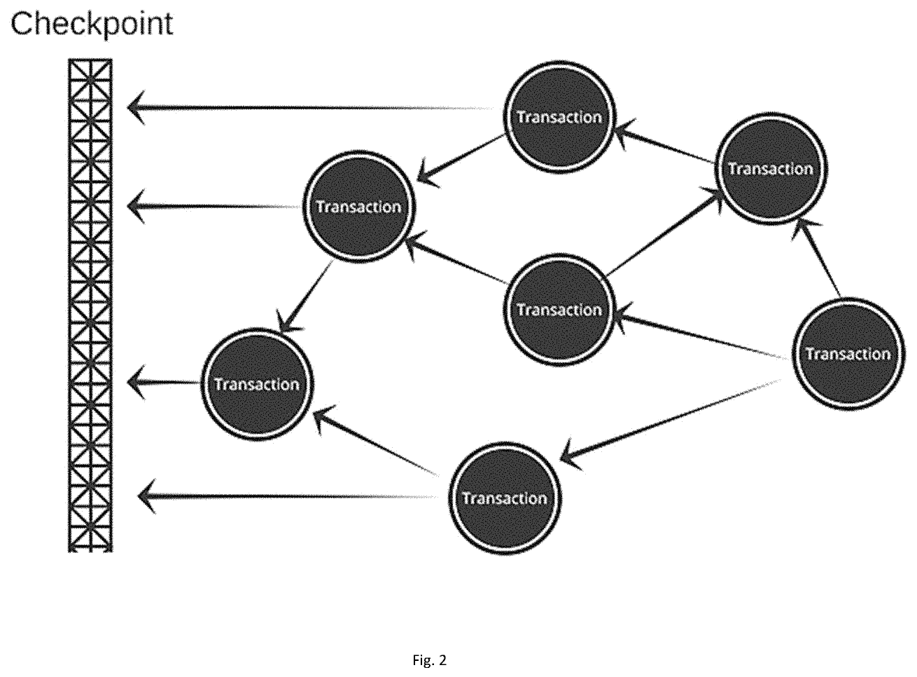

### See FIG. 2 Direct Acyclic Graph With Checkpoint.

Checkpoints within the graph are formed to receive part signatures by multiple Minters in the network R≥₅. Which Minters validate and sign which checkpoints is determined by two elements.

First, a sharding algorithm responds to the transaction load within the network as messages are broadcast. This algorithm is responsible for determining the number of Minters in the next subgroup assembled to create the next checkpoint. The distributed beacon's current broadcast value, a random value, is used to select Minters into the subgroup. The intention being any Minter at any time may be assigned into the next group of Minters to create a checkpoint.

A checkpoint is created when enough Minters, using a code-based post-quantum secure ring signature algorithm, have signed the checkpoint. Similar to ring signature schemes, a (t, N) threshold ring signature scheme allows at least t signers in the ring of N signers to cooperate with each other to sign a message.

Herein lies the cooperation: Minters can only become part of t signers in the ring of N signers by agreeing on the true state of the chain with other Minters assigned to creating the new checkpoint. The identities of the Minters assigned to creating the new checkpoint are not known amongst the individual Minters in in the group when initially assigned.

Herein lies the competition: The Minters who are able to become a part oft signers in the ring of N signers are rewarded with Qredo for creating the checkpoint. The Minters who are in the N−t group, i.e., the ones who cannot get their signatures computed into the threshold before other Minters complete the threshold scheme and broadcast widely to the network−they receive nothing. Hence, speed is essential. Computational power to deduct the true state of the chain is necessary, but more important are assets such as bandwidth and global points of presence to broadcast updated or final checkpoint messages faster than your competition.

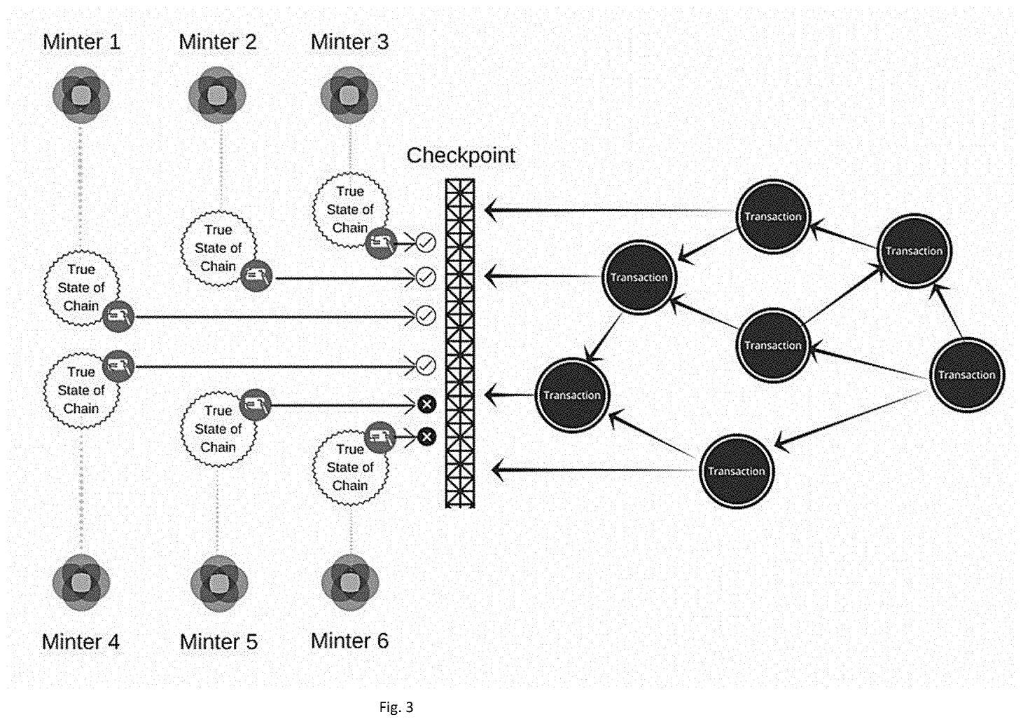

### See FIG. 3. Competition Among Minters.

Specifically, winning the reward means computing the true state of the chain from the outstanding unverified transactions that reference the last checkpoint, agreeing with other Minters about its true state, part signing a checkpoint message to complete it and broadcasting the checkpoint message to achieve network replication.

Qredo's Proof of Speed achieves consensus on the true state of the chain by way of a checkpoint accumulating the most references from transactions placed ahead of it. Each full Qredo client, by referencing the checkpoint in the transaction it posts by inserting a hash of the checkpoint into the transaction message, casts a vote for what it believes to be the legitimate checkpoint.

Each Minter and full Qredo client in the network that receives the first complete and correct checkpoint message will forward to other nodes until replication throughout the network attained.

Stated another way, a complete and correct checkpoint message that replicated throughout the network achieves consensus on its legitimacy when it has the highest number of transaction messages in front of it vs all other complete and correct broadcast checkpoint messages. It stands to reason that the first complete and correct checkpoint message to achieve full replication throughout the network will occupy this position.

A legitimate checkpoint becomes a permanent when the next checkpoint in front of it references back to it by using the public parameters the checkpoint pre-selected for the next checkpoint in front of it.

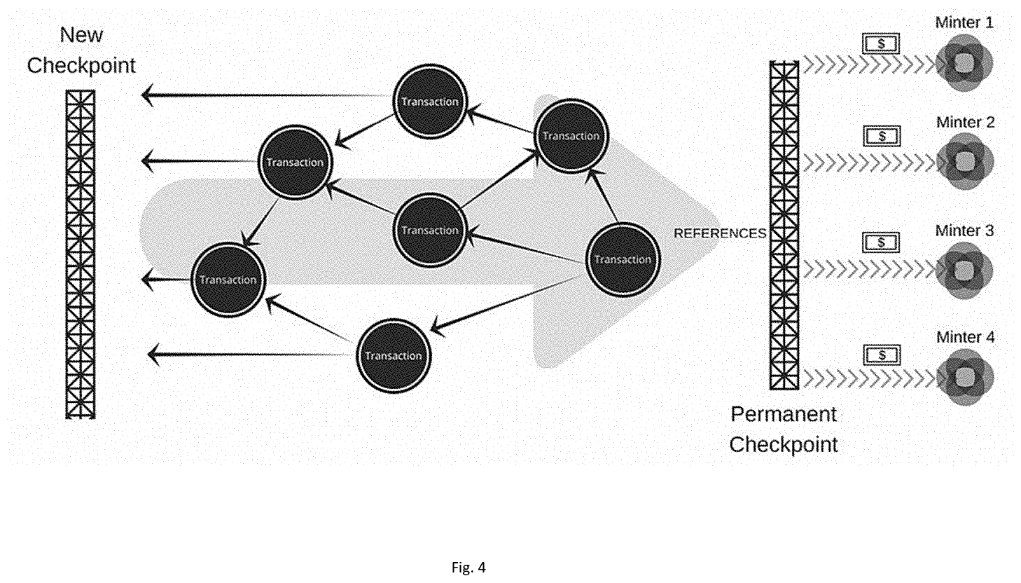

To sum it up, Proof of Speed does rely on a small ‘micro’ proof of work: Figuring out what the true state of the chain is. See FIG. 4. Successful Minters are compensated when a checkpoint becomes permanent.

When the checkpoint becomes permanent, the Minters whose signatures formed the threshold to complete the checkpoint message receive their reward in Qredo for validating the true state of the chain.

### 2.2.1. Qredo Minter's Threshold Ring Signature Protocol

From here, we use the formal definition of a threshold ring signatures scheme described in] E. Bresson, J. Stern, and M. Szydlo. Threshold ring signatures and applications to ad-hoc groups. Future Generation Computer Systems, 2002 incorporated by reference herein.

Let us assume there are N signers of Sᵢ, i≤i≤N, forming a ring R and the threshold of generating a valid signature is t with t<N. For simplicity, we assume the first t signers of Sᵢ, . . . ,Sₜ are the true signers in R. A (t, N) threshold ring signature scheme consists of four algorithms (Setup, KeyGen, Sign, Verify).

Setup(λ). Given a security parameter λ, the algorithm chooses integers n, k, d, and w to, respectively, represent length, dimension, minimum distance, and error-correcting ability of the code underpinning the scheme. The algorithm outputs the system public parameter, P=(n, k, d, w).

KeyGen(P). Given P=(n, k, d, w), the algorithm takes as input the parameter P and generated N pairs of public-private keys (pkᵢ,skᵢ) for the signers Sᵢ ∈ 1≤i≤N. The N public keys pk₁, 1≤i≤N form the ring public key P K={pk₁, pk₂, . . . , pk_{N}} and each private key skᵢ is sent to the signer Sᵢ via a secure channel,

1≤i≤N.

Sign(m, P, P K, TSK). The algorithm takes as input a message m, the parameter P, the ring public key P K, and a private key set TSK={sk₁, . . . ,skₜ} of t signers and outputs a threshold ring signature σ on m.

Verify(m, P K, σ), The algorithm takes as input the message m, the ring public key P K, and the threshold ring signature σ, and outputs 1 if (m,σ) is a valid message-signature pair. Otherwise the output is 0.

A few observations about the threshold ring signature protocol that will be expanded on in the following sections. A Minter who forms a checkpoint message takes the role of ‘leader’ S1 in the signature protocol. It is expected that every minter will create a checkpoint message and the competition is really twofold. First, can the Minter be fast enough to elicit signatures from other Minters to complete its threshold signature on the checkpoint message it formed. Second, can the Minter be fast enough to respond to requests to sign other Minter's checkpoint messages. A Minter is compensated by being the creator of a legitimate checkpoint message that has been formalized as permanent, or by being part of the threshold group of signatures on another Minter's legitimate checkpoint message that is formalized as being permanent. In other words, Proof of Speed is not a zero sum game.

When creating their checkpoint message, the leader must use the public parameters P pre-selected by the last threshold signer incorporated on the last known complete and correct legitimate checkpoint. These public parameters in the last checkpoint were ‘certified’ as the public parameters to use in the next checkpoint by way of consensus reached on the legitimacy of the previous checkpoint.

The leader must generate the private keys skᵢ for other Minters so they can sign the leader's checkpoint message. In addition to creating these private keys, its the leader's responsibility to securely communicate the private keys to the other Minters.

The leader must be highly available so it can serve the checkpoint message to other Minters in a way that takes advantage of the protocol's ability to have other Minters sign the checkpoint message concurrently (i.e., at the same time). A concurrent signing process vs an ordered signing process is much more efficient and serves Qredo's aim of high transaction throughput.

The leader in the protocol must be highly available to receive from the Minters who have signed a checkpoint message a set of vectors (eᵢ, eᵢ₍ₜ₊₁₎, eᵢ₍ₜ₊₂₎, . . . , e_{iN}), 1≤i≠l≤t that are necessary to finalize the threshold. These vectors are generated by the Minter after it has signed the checkpoint message. Without the vector, the Minter's signature won't work in the threshold, and the threshold may not complete.

The leader in the protocol is responsible for setting the number of signers in the threshold, after he receives the Minter's generated vectors. The threshold is coded into the protocol as being a simple majority from the set of N, but mechanisms must be in place to keep the Minter honest. A dishonest Minter could modify their software to select a threshold of 1 to propagate a double spend attack or keep all of the rewards from creating a checkpoint.

Critically, as a final step, the leader must generate a new public parameter P=(n, k, d, w) for the next checkpoint and append P these public parameters to the checkpoint message along with its complete and correct threshold signature. The Minter, acting as the leader of the protocol, is then ready to broadcasting a completed and correct checkpoint message to the network at large.

Prior to Qredo's ‘Genesis Transaction’ there is first a public parameter, or a Genesis Parameter. From then on each checkpoint will have public parameters pre-computed for the next batch of Minters who are randomly selected to the group tasked to create the next checkpoint.

It is expected that for the max N signers of Sᵢ, 1≤i≤N, assuming that all signers are in agreement about the state of the chain, eventually, there could be N potential checkpoints from which to anchor the chain to go forward. These checkpoints, while having the right answer, but still losing the competition, are an advantage in that they provide an additional assurance about the true state of the chain.

For example, 3 of 5 Minters (S₁, S₂, S₃) in the “winning” threshold group obviously agreed the true state of the chain was x, and created checkpoint A, with S₃ having selected public parameters of PA

Minters 3, 4, and 5 (S₃, S₄, S₅) were in a losing threshold group and created checkpoint B, which was broadcast after A, yet had the same result for the true state of the chain, also x.

One avenue of exploration is to exploit the ‘losing’ checkpoints in the event that nodes going offline during the consensus process. One can imagine that full Qredo clients, in the event that nodes go offline so that consensus is not reached on the next checkpoint in the chain, can still select any verified checkpoint that had been broadcast.

Since both checkpoints A and B are valid in that they both express the same state of the chain x, and each of them return valid topological orders back to the previous checkpoint (the ordered set of vertices that is the returned result of running topological sort), an opportunity exists to merge those transactions referencing the orphaned checkpoint B into a new checkpoint.

Another avenue will be to formalize a division of edges in the graph to Minters working in subgroups, so that an extremely wide set of transactions can be supported for peak loads through the network. In practice, there should be only a few scenarios whereby the state of the chain is not universally agreed upon. An obvious case is the work of malicious Qredo clients on the chain, or the work of malicious Qredo Minters. The proof that Qredo protects against these threats is covered in depth in following sections.

### 2.3. Zero Knowledge Proof of Membership

In the interest of clarity, this paper covers the application of the decentralized random beacon, key to randomly selecting Minters into groups, and the sharding algorithms used to decide the size of the Minter group N creating the checkpoint, in following sections.

For now, we start from the point where Minters have been selected for creating the next checkpoint. The Minter becomes aware it has been randomly selected to a group to create the next checkpoint, and it knows the number of Minters in the group. Beyond that, its knows nothing else. In 2015, M. Scott, B. Spector, and G. Yamamoto. M-pin: Zero-knowledge two-factor authentication for digital identity. Internet-Draft draft-scott-mpin-00, IETF Secretariat, December 2015. incorporated by reference herein created a secure, efficient, 1-pass zero-knowledge proof identity requiring the use of a trusted authority to act as a private key generation service—a requirement of most classic IBE schemes. In 2016, J. Bootle, A. Cerulli, P. Chaidos, J. Groth, and C. Petit. Efficient zero-knowledge arguments for arithmetic circuits in the discrete log setting. Cryptology ePrint Archive, Report 2016/263, incorporated by reference herein advanced efficient zero-knowledge arguments using knowledge of openings of two Pedersen multi-commitments. Further work described in] B. Bu\ddot{ }nz, B. Bootle, D. Boneh, A. Poelstra, P. Wuille, and G. Maxwell. Bulletproofs: Short Proofs for Confidential Transactions and More. Cryptology ePrint Archive, Report 2017/1066, incorporated by reference herein created a new non-interactive zero-knowledge proof protocol with very short proofs and without requiring a trusted setup or any trusted authority, critical for decentralized applications.

Recent work described by Bootle created a framework for expressing simple relations between commitments and field elements, creating zero-knowledge arguments considerably more efficient than Bootle et al. in the case where the poly-nomials in the relation have low degree. Using these methods Qredo deploys zero knowledge batch protocols, which allows many copies of the same relation to be more efficiently proved and verified in a single argument. The protocols are instantiated with concrete polynomial relations to construct zero-knowledge arguments for membership proofs, polynomial evaluation proofs, and range proofs.

Membership arguments allow a prover to commit to a secret value and show that it lies in a public set, without leaking information on the value. Zero-knowledge sets allow the prover to commit to a secret set, and handle membership and non-membership queries in a verifiable manner, without leaking information on the set.

Therefore, as a first step, the Minter creates a zero knowledge proof of membership in the newly created group which does not leak information on the group itself, or the methods by which it ascertained it was a member in the group.

The Minter does this by using the value which declares its membership in the group of Minters assigned to create the checkpoint as a secret, committed value which is an element of a list L={λ₀, . . . , λ_{N-1}}—the list being the Minters selected to create the next checkpoint.

This zero knowledge proof NIZK, once broadcast on the Qredo network, can be verified by any Minter or Qredo full client. The identities of the signers/Minters is initially unknown among the randomly selected Minters in the group. The zero knowledge proof of membership is used as an authentication between the Minters who have been selected to create the next checkpoint that a particular Minter is part of that group.

### 2.4. Threshold Ring Private Key Distribution

Recall that the threshold ring signature algorithm requires that each private key sk₁ is sent to the signer Si via a secure channel, 1≤i≤N.

Recall also that each Qredo Minter selected to create a new checkpoint will be using the public parameters P pre-selected on the legitimate checkpoint.

Therefore, when creating a new checkpoint, since Setup was already ascertained, a Minter should be able to begin the following KeyGen protocol (in depth):

KeyGen(P). Given P=(n, k, d, w), the Minter running the algorithm performs the following:

(i) For each signer Sᵢ in the ring R={Sᵢ|1≤i≤N}, choose a parity-check matrix Hᵢ of a w-error correcting irreducible [n, k, d] Goppa code, which has a corresponding fast decoding algorithm D E CHᵢ, 1≤i≤N.

(ii) For each signer Sᵢ ∈ R, choose a random binary (n−k)×(n−k) invertible matrix Q, and a random permutation n×n matrix Pᵢ, 1≤i≤N.

(iii) Compute

H\tilde{ }=QᵢHᵢPᵢ, 1≤i≤N. (1)

(iv) For each signer Si ∈ R, set the private key skᵢ=(Qᵢ, Hᵢ, Pᵢ, D E C_{Hi}) and public key pkᵢ=H\tilde{ }i, 1≤i≤N.

The ring public key is

P K=(H\tilde{ }_{1≤i≤N})=(H\tilde{ }₁, H\tilde{ }₂, . . . , H\tilde{ }_{N}) (2)

and each private key skᵢ=(Qᵢ, Hᵢ, Pᵢ, D E C_{Hi}) is sent to the signer Sᵢ via a secure channel, 1≤i≤N. A critical question arises from following the steps above. How will the Minters authenticate to each other and securely communicate the private key(s) they would like the other Minter(s) to use in order to sign the checkpoint messages they create?

To solve this issue, Qredo utilises the highly performant and quantum-resistant Supersingular Isogeny Key Encapsulation (SIKE) 2-pass protocol described by C. Costello, L. D. Feo, D. Jao, P. Longa, M. Naehrig, and J. Renes. SupersiInternet, 2017 and incorporated by reference herein. Immediately following the creation of the zero knowledge proof of membership, the Minter should create its public/private key pair using the SIKE protocol.

(pk, sk)←ₛ KGen−_{(SI K E)}

The zero knowledge proof of membership provides the other Minters with assurances that the public keys broadcast across the network are generated by Minters who have been selected to create the next checkpoint, and are not the work of imposters seeking a chance to subvert the network.

Our workflow to create a checkpoint message now begins to take shape.

The first message broadcast out by a selected Minter (First Minter) is a concatenation of the zero knowledge proof of membership together with its public key appended with a hash of the entire message. All Minters selected will perform this operation.

H(pk+NIZK)+pk+NIZK

These messages are replicated across all full Qredo clients and Minters. A Minter will expect to receive N−1 messages from other Minters randomly selected to the checkpoint creation group.

Once a Minter receives an inbound message, it assumes the role of a Leader Minter. The Leader Minter verifies the integrity of the message Vf and runs the verifier protocol V on the zero knowledge proof of membership. Assuming both check, the Leader Minter runs the isoexᵢ flow of the SIKE protocol input the Leader Minter's secret key ski and the First Minter's public key pk_{f} to create a shared secret key skS.

The Leader Minter has run the KeyGen protocol N number of times to generate a ring threshold signature private key (skᵢ=(Qᵢ, Hᵢ, Pᵢ, D E C_{Hi}) for each member randomly selected to the checkpoint creation group.

The Leader Minter's response message to the First Minter's message will contain an encryption of the second threshold ring signature private key Encₛₖ₂ from the entire set list of keys generated, assuming that this is the first Minter to respond to the initial message. The first key will have been used Encₛₖ₁ by the Leader Minter immediately putting the first signature to the checkpoint message they created.

The original protocol, when signing a given message m, system parameter P, ring public key P K=(H\tilde{ }_{1≤i≤N}), and private key set TSK=(sk_{1≤i≤t}) of t signers, where ski=(Qᵢ, Hᵢ, Pᵢ, D E C_{Hi}) for each 1≤i≤t, the algorithm first elects a leader Sₗ randomly from the involved signer set {Sᵢ|1≤i≤t}. Note that Sₗ is just a signer participating in the signing process without any additional privileges. Here we modify the protocol so that the Leader Minter is the protocol leader as well. The protocol leader does have the responsibility of finalizing the signature, therefore sensible to make this subtle change.

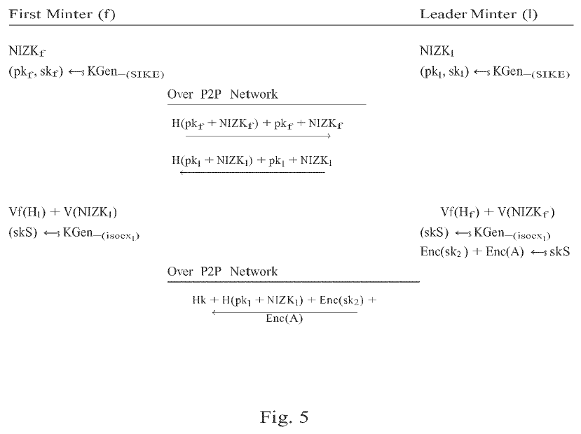

The response message contains an encryption of an address EncA from which the First Communication can initiate direct communication with the Leader Minter. Many technologies like libP2P libp2p specifications, 2018, incorporated by reference herein, are available which are capable of discovering other peers without resourcing to centralised registries, enabling apps to work disconnected from the backbone, free from runtime and address services, independently of their location. It is assumed Qredo will utilise such components for addressing. See FIG. 5.

In the real world, the First Minter would have already received the Leader Minters initial outgoing message and would have run the runs the verifier protocol V on the Leader Minter's zero knowledge proof of membership NIZKₗ as well as verifying the integrity of the entire message Vf(_{Hl}). Therefore it is reasonable to expect it will run the same secret key generation skS using as input the Leader Minter's public key pkₗ and its private key sk_{f}. As such, it is only necessary to append the H(pk₁+NIZKₗ) to the response message. Finally, the response message contains a hash H∥ of all parts of the message concatenated together.

For clarity, from here we focus exclusively on the flows between First Minter and Leader Minter excluding the operations the First Minter would make assuming the role of a Leader Minter.

### 2.5. Threshold Ring Signature Flow

Picking up the next step, the First Minter receives the encrypted second threshold ring signature private key Encₛₖ₂ and encrypted address EncA in order to communicate directly with the Leader Minter. The First Minter verifies the message, compares the original hash H(pk₁+NIZKₗ) to the original for lookup of the correct secret key skS to decrypt the encrypted items.

After decrypting the address A, the First Minter initiates a direct connection to the Leader Minter. It is incumbent on the Leader Minter to serve the same checkpoint message to all Minters attempting to sign, as the threshold ring signature algorithm supports concurrent message signing from all Minters. Accessing the checkpoint message, the First Minter initiates the signing portion of the protocol.
(i) For eacg Sᵢ, 1≤i≠1≤t, randomly choose eᵢⱼ ∈ F₂ⁿ, j=t+1. f+2, . . . , N, and compute

$${s}_{i}^{T} = {h ( m )}^{T} + {\sum }_{j = i + 1}^{N} {\tilde{H}}_{j } {e}_{ij}^{T} , 1 \leq i \neq l \leq t , \qquad ( 3 )$$

where h: {0,1}→{0,1}^{n-k} is a one-way collision resistant hash function.
(ii) For each [symbol] , 1≤i≠1≤t, compute Qᵢ⁻¹sᵢ^{T}. If Qᵢ⁻¹sᵢ^{T} is a decodable syndrome, compute [symbol] _{H}_{ᵢ}(Qᵢ⁻¹sᵢ^{T}) to obtain a vector e′ᵢ such that

Hᵢe′ᵢ^{T}=Qᵢ⁻¹sᵢ^{T}. 1≤i≠1≤t. (4)
Otherwise, return to the previous step to recompute sᵢ.
(iii) Compute

eᵢ^{T}=Pᵢ^{T}e′ᵢ^{T}, 1≤i≠1≤t. (5)
For all signers Sᵢ, 1≤≠1≤t, the above signing processes can be concurrent.
The First Minter (and all Minters in this role) conclude by sending N−t+1 generated sectors (eᵢ, eᵢ₍ₜ₊₁₎, eᵢ₍ₜ₊₂₎, . . . , e_{iN}), 1≤i≠1≤t, to the Leader Minter [symbol] ₗ.
(iv) Upon receiving all vectors, (eᵢ, eᵢ₍ₜ₊₁₎, eᵢ₍ₜ₊₂₎, . . . , e_{iN}), 1≤i≠1≤t, the Leader Minter Sᵢ executes the following steps:
   (a) For each t+1≤j≤N, choose a random eᵢⱼ under the condition

wt(eᵢⱼ+Σ_{i=1, i≠1}^{t}eᵢⱼ)=w, Set

$${e}_{j} = {\sum }_{t = 1}^{t} {e}_{ij} , t + 1 \leq j \leq N . \qquad ( 6 )$$

(b) If t is an odd number, then compute

$${s}_{i}^{T} = {h ( m )}^{T} + {\sum }_{j = i + 1}^{N} {\tilde{H}}_{j} {e}_{ij}^{T} . \qquad ( 7 )$$

Otherwise (i.e., t is an even number), compute

$${s}_{i}^{T} = {\sum }_{j = i + 1}^{S} {\tilde{H}}_{j} {e}_{ij}^{T} . \qquad ( 8 )$$

(c) Compute Qₗ⁻¹sₗ^{T}. If Qₗ⁻¹sₗ^{T} is a decodable syndrome, compute [symbol] _{H}_{ₗ}(Qₗ⁻¹sₗ^{T}) to obtain an vector e′ₗ such that

Hₗe′ₗ^{T}=Qₗ⁻¹sₗ^{T}. (9)
Otherwise, return to the first step executed by [symbol] ₗ to choose another eᵢⱼ.
(d) Compute

eₗ^{T}=Pₗ^{T}e′ₗ^{T}, (10)
(e) Output σ=(e₁, e₂, . . . , e_{N}) as the threshold ring signature on the message m.

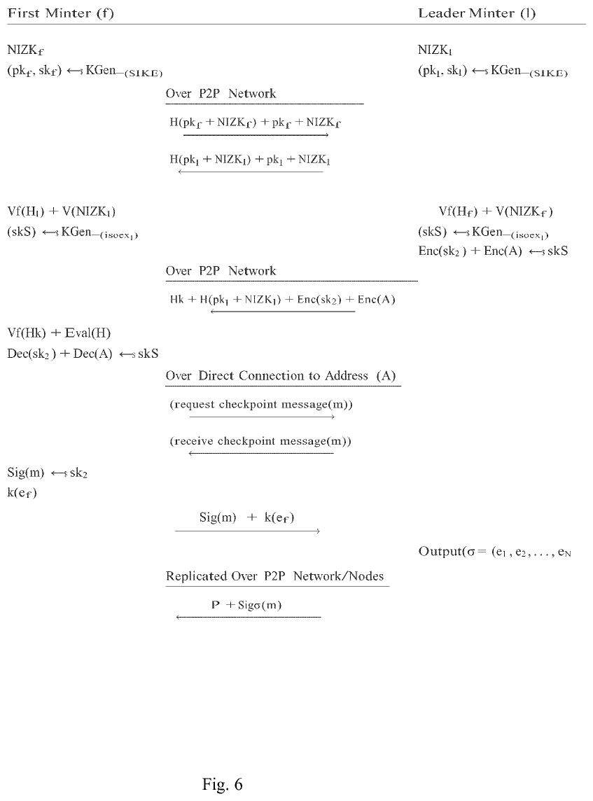

Viewing the checkpoint message communication flow from beginning to end, we incur 6-passes of interactivity between the First Minter (and any Minter in this role) and the Leader Minter, excluding any flows that switch the roles of the participants. The final broadcast is the complete and correct signature a broadcast to all nodes. See FIG. 6.

This process is will occur t−1 times until the threshold signature is complete as noted by P+Sigσ(m) above.

Operating Environment: The system is typically comprised of a central server that is connected by a data network to a user's computer. The central server may be comprised of one or more computers connected to one or more mass storage devices. The precise architecture of the central server does not limit the claimed invention. In addition, the data network may operate with several levels, such that the user's computer is connected through a fire wall to one server, which routes communications to another server that executes the disclosed methods. The precise details of the data network architecture does not limit the claimed invention. Further, the user's computer platform device may be a laptop or desktop type of personal computer. It can also be a cell phone, smart phone or other handheld device. The precise form factor of the user's computer platform device does not limit the claimed invention. Further, the customer may receive from and transmit data to the central server by means of the Internet, whereby the customer accesses an account using an Internet web-browser and browser displays an interactive web page operatively connected to the central server. The central server transmits and receives data in response to data and commands transmitted from the browser in response to the customer's actuation of the browser user interface. The program can detect the relative location of the cursor when the mouse button is actuated, and interpret a command to be executed based on location on the indicated relative location on the display when the button was pressed. Similarly, the program can detect the location of a touch on the screen. The data file may be an HTML document, the program a web-browser program and the command a hyper-link that causes the browser to request a new HTML document from another remote data network address location. The data file may also contain scripts, which are computer program commands, which are executed by the browser. The data file may also contain references to objects stored either locally or remotely that the browser may then access and display or otherwise render. The browser can thereby fetch additional data that is stored on a remote server accessed using the Internet.

The Internet is a computer network that permits customers operating a personal computer to interact with computer servers located remotely and to view content that is delivered from the servers to the personal computer as data files over the network. In one kind of protocol, the servers present webpages that are rendered on the user's computer platform using a local program known as a browser. The browser receives one or more data files from the server that are displayed on the customer's personal computer screen. The browser seeks those data files from a specific address, which is represented by an alphanumeric string called a Universal Resource Locator (URL). However, the webpage may contain components that are downloaded from a variety of URL's or IP addresses. A website is a collection of related URL's, typically all sharing the same root address or under the control of some entity.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention. The logic described herein may be expressed by computer code that is performed by the computers comprising the system when that code is executed by the computer system. For example, where the disclosure recites a determination whether a condition exists, this may be accomplished by the computer code including a conditional branching statement using a Boolean logical condition, and then that statement resulting in alternative processes steps being executed based on the data representation of the condition being determined. In other embodiments, where the disclosure recites a determination, it may be that the computer executes program steps that run a calculation using data representing input state conditions in order to calculate data as a result that represents such a determined result. Similarly, when the invention is described as executing a selection, that may be by the computer system executing code that repeatedly loops on a Boolean logical condition of matching one data value against a set of other data values until a matching data value is found.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory. The CPU may perform logic comparisons of one or more of the data items stored in memory or in the cache memory of the CPU, or perform arithmetic operations on the data in order to make selections or determinations using such logical tests or arithmetic operations. The process flow may be altered as a result of such logical tests or arithmetic operations so as to select or determine the next step of a process. The CPU may change an addressing pointer for the next instruction to execute based on the result of such a logical test and thereby perform the change in process flow dependent on the determined logical state.

Examples of well known computing platforms, systems, environments, and/or configurations that may be suitable for use with the invention include, but are not limited to, personal computers, server computers, hand-held, laptop, tablet or mobile computer or communications devices such as cell phones, smart phones and PDA's, multiprocessor systems, microprocessor-based systems, set top boxes, programmable consumer electronics, network PCs, minicomputers, mainframe computers, distributed computing environments that include any of the above systems or devices, and the like. These may operate using as an operating system Windows, iOS, OSX, Android, Linux, Unix, Symbian and Blackberry including the various versions and variants thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., a scripting language, like JAVA, Java Script, an assembly language, or a high-level language such as FORTRAN, C, C++). The source code may be compiled before execution and distributed as object code that is executed on the target computer or compiled as it is executed by the target computer, in each case for use with various operating systems or operating environments. The source code may define and use various data structures and communication messages. The source code may be in a computer executable form (e.g., via an interpreter), or the source code may be converted (e.g., via a translator, assembler, or compiler) into a computer executable form. The steps of

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting. It is appreciated that any of the software components of the present invention may, if desired, be implemented in ROM (read-only memory) form. The software components may, generally, be implemented in hardware, if desired, using conventional techniques.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention, as defined by the following claims.

What is claimed:

1. A computer system of storing data representing at least one cryptocurrency transaction between a first party and a second party comprised of at least one computer connected to a digital network, said system further comprised of:
A first data structure stored in computer memory representing a first graph comprised of at least one data record corresponding to the at least one cryptocurrency transaction;
A second data structure stored in computer memory representing a second graph, said second data structure comprised of at least one transaction record accessible using only a corresponding symmetric key;
Where the at least one data record in the first data structure is further comprised of an identifier corresponding to the at least one cryptocurrency transaction and a corresponding reference to the at least one transaction record in the second data structure; and
At least one computer sub-system operating a validating process that validates for the at least one cryptocurrency transaction, the corresponding at least one transaction data records in the first and second data structures.

2. The system of claim 1 where at least one of the validating sub-system processes, for the corresponding cryptocurrency transaction, further confirms a first and a second digital signature corresponding to the transaction data record comprising the second data structure.

3. The system of claim 1 where the at least one validating sub-system further operates a proof of speed protocol.

4. The system of claim 1 where the data record in the first data structure is further comprised of a hash of a checkpoint data.

5. The system of claim 1 where the at least one validating subsystems are selected to generate as a group a data representing a checkpoint.

6. The system of claim 5 where the at least one validating sub-system operates a process to compute a validation of the state of the at least one transaction data records in the second data structure using at least as part of the input into the computation, a subset of data records that have not been validated but are comprised of data referencing the data representing the checkpoint.

7. The system of claim 5 further comprising a module comprised of logic that when operated utilizes a zero knowledge proof protocol to authenticate that one of the validating subsystems is one of the selected group.
